(19) United States
(12) Patent Application Publication
(10) Pub. No.: US 2016/0051444 A1
(43) Pub. Date: Feb. 25, 2016

(54) INSTALLATION FOR MANUFACTURING A BAG FOR MEDICAL PURPOSES, METHOD FOR MANUFACTURING SUCH A BAG, INJECTION STOPPER AND BAG FOR MEDICAL PURPOSES

(71) Applicant: KIEFEL GMBH, Freilassing (DE)

(72) Inventor: Friedrich MUTH, Espelkamp (DE)

(73) Assignee: KIEFEL GmbH, Freilassing (DE)

(21) Appl. No.: 14/778,672

(22) PCT Filed: Mar. 24, 2014
(86) PCT No.: PCT/DE2014/000150

§ 371 Date: Sep. 21, 2015

(30) Foreign Application Priority Data
Mar. 24, 2013 (DE) 10 2013 005 272.6

(51) Int. Cl. A61J 1/10; B31B 1/84; B65D 33/16; B31B 1/64

(52) U.S. Cl. CPC A61J 1/10; B31B 1/64; B31B 1/84; B65D 33/16

(57) ABSTRACT

The invention relates to an installation and a method for manufacturing infusion bags with an access and an injection stopper. In addition, the invention relates to such a bag and to various injection stoppers.

In the system according to the prior art, a tube piece, onto which the port is fitted, is welded into a bag. The port is not additionally fixed but is merely held by the tension in the tube. This can theoretically lead to impermeability problems.

In contrast, in the new system proposed herein, the port is directly welded into the bag, so that the tube serving as an intermediate piece is dispensed with. The resulting advantage is more specifically that more than 30 mm of tubing can be saved in each bag, which not only makes the construction of the installation less expensive, but also eliminates the relatively expensive tubes.

In addition, the tube and the port can be optionally welded with the same welding tool. The operator of the installation can decide whether he welds one tube and one port or two tubes. This does not require changing the tool.

If the operator of the installation welds two tubes onto the bag, it is still possible to fit standard ports according to the prior art onto the tubes.

The invention relates to an installation for manufacturing a bag for medical purposes, more specifically an infusion bag, a method for manufacturing such a bag, an injection stopper for such a bag and the bag itself.

Bags for medical purposes are widely known from the prior art. In addition to holding infusion solutions, such bags can also mainly be used for storing blood and for storing sterile medical liquids.

The bags are equipped with a filling and extraction system, which, as a rule, is referred to as a port, or in accordance with the German term, as an “extraction stopper” on the extraction side and as an “injection stopper” on the injection side, when several filling and extraction possibilities are provided.

As a rule, an access to the inside of the bag is created by welding a plastic tube with various forms, diameters, wall thickness or material hardness between the two film layers which ultimately form the bag. As soon as the bag is manufactured and the access has been welded in, the bag can be filled, which often already takes place in the production installation, wherein it must be explicitly pointed out that the present invention also relates to bags that are not filled. The access or the accesses are then closed with a stopper. The stopper is firmly and tightly jammed in the access tube.

It is often desirable that qualified medical professionals be able to inject an active substance into the liquid in the bag. To this end, such a bag has an injection stopper. In simple terms, the injection stopper is a stopper with a rubber seal centrally located in the body of the stopper and which can be penetrated with the injection needle of a conventional syringe. The needle passes through the soft elastomeric material of the seal and, when the length of the needle and the length of the access and of the injection stopper are optimally adapted to each other, ends close to the inside of the bag, in order to achieve a homogeneous dispersion of the active substance to be injected, but does not leave the access, i.e. the harder plastic tube; in particular, the needle does not get inside the bag, so that it cannot mechanically damage the bag. When the specialized personnel pulls the injection needle out of the injection stopper, the rubber seal closes the puncture under the pressure with which it is inserted, and the bag is again sealed off.

The welding of a plastic tubule between two plastic layers, for example by high frequency welding, wherein the present invention is not limited to high frequency welding but also deals at least with thermal welding of plastic films, can be gathered for example from WO 2007/140760 A2.

An advantageous method for filling manufactured bags can be gathered from WO 2012/006980 A2.

DE 10 2014 051 556 B4 discloses a device and a method for manufacturing plastic bags with one or several ports. It particularly proposes a special geometry of the access pieces. In addition, this publication refers to DE 196 34 944 C1, to DE 199 58 952 A1, to DE 692 16 991 T2 and to U.S. Pat. No. 4,352,669.

When an access consists of a tube and the film is made of polypropylene, the material used is mostly also polypropylene. The softening point of polypropylene lies at approximately 140° C. The sterilization of the bags takes place at 121° C., so that many materials with a lower fusion or softening point do not qualify for most applications.

The problem underlying the present invention is to improve upon the prior art or to provide an alternative.

According to a first aspect of the present invention, this problem is solved by an installation for manufacturing a bag for medical purposes from two film layers, an access and an injection stopper, wherein the access comprises a tube, wherein the installation is characterized in that it is set up to weld an injection stopper with an integrally formed access between the film layers.

In this regard, the following terms must be explained:

The category of installations for producing such bags is commonly referred to as “thermoforming installations”.

The two “film layers” are preferably two separate film layers, but can also be for example a film tube or a folded film strip resulting in at least two layers.

At this point it should be noted that within the framework of the present patent application, indefinite articles such as “one . . . ”, two . . . ”, must be understood as “at least” information, i.e. as “at least one . . . ”, “at least two . . . ” etc., unless it follows from the particular context that “precisely one . . . ”, “precisely two . . . ” etc. should be meant there.

Here, the access is referred to as a “tube”. In practice, there is often also talk of a “pipe” or “tubules”. Within the framework of the present patent application, a pipe shall be considered as a subcase of a tube, both being however preferably made of a plastic material.

The “injection stopper” should be set up with an elastomeric sealant to allow an injection needle to be stuck through it and thus get into the access or even through the access.

The presented first aspect of the invention provides that the access must be formed integrally with the injection stopper. A one-piece access/injection stopper element is thus obtained that no longer requires welding a separate access to the bag and subsequently inserting the injection stopper. Rather, the access to be welded between the films is already equipped with the injection stopper and thus tight. A production step is thereby dispensed with.

If the bag is to be filled, it is proposed to setup the installation to weld in a second access, in addition to the proposed one-piece access/injection stopper element, namely in the conventional manner with an open tube piece. Filling can take place through the open tube piece. Although filling takes twice as long, because only one of two accesses can be used, since the other one is already closed, the elimination of the separate accesses in the form of tubes is substantially cheaper, and the otherwise occurring, risky sealing effect between the access tube and the inserted stopper is avoided. Instead, a system manufactured so that it is already intrinsically separate and tightly sealed is now tightly welded to the bag.

As a rule, an access welding tool is provided in the installation. When this is the case, it is proposed that the access welding tool has a supply of injection stoppers that are separate from the accesses, preferably of access/injection stopper systems that are separate from the accesses.

In the simplest case, such an installation is setup to process accesses and injection stoppers known from the prior art, because if separate injection stoppers can be supplied, it is not necessary that the installation only process integrally formed access/injection stopper systems.

It is preferably additionally, but not necessarily, provided that the access welding tool has a supply of accesses that are separate from injection stoppers.

Such an arrangement allows processing conventional accesses, i.e. for example simple tubing pieces that are welded between the films. If, in addition, there is a supply of separate injection stoppers, the accesses can be closed immediately or later on.

Alternately or cumulatively it is provided that the access welding tool has a supply of one-piece combined access/injection stopper elements.

In any case, an installation set up in this manner can process the proposed one-piece combined access/injection stopper elements and weld them between the films.

When all three afore-mentioned supplies are provided, the installation can optionally switch between the various systems. Consequently, it is then proposed to provide several of the supplies for alternative application.

An installation that can process the one-piece combined access/injection stopper elements, more specifically weld them between the film layers, is preferably devoid of an injection stopper plug-on station, which makes it possible to construct the installation at lower costs.

According to a second aspect of the present invention, the problem is solved by a method for producing a bag for medical purposes from two film layers, an access and an injection stopper in an installation, wherein an injection stopper with an integrally formed access in form of a tube is used in the installation, and the access is welded between two film layers, wherein welding is carried out on the access.

It has already been explained that the bag for medical purposes can more specifically refer to an infusion bag.

The manufacturing method proposed herein corresponds essentially to the same idea as the previously described installation: an integrally formed element is to be processed, which comprises both the access, mostly in form of a tube, and the injection stopper, both on a prefabricated element. The fact that the two elements must be formed integrally does not necessarily mean that they must be made of the same material. Rather, in most cases, using a combination of different materials will make sense, for example a tubular construction made of a harder or softer plastic material and a rubber seal, or generally an elastomer seal, inserted in it, preferably with polyisoprenes, wherein, in a special implementation, stoppers are included, that can be pierced only once, for example twist-off stoppers, which are not provided with an elastomeric seal, so that, most of the time, two of four wings are twisted off, whereupon a spike port is pushed in, which must then stay therein. When the spike port is removed, the stopper is no longer sealed. In contrast, twist-off stoppers are mostly made of only one material.

Within the framework of the present application, the term “one-piece” primarily refers to the fact that the element is a pre-fabricated assembled element.

In a preferred implementation, the “one-piece” connection of the structure between the access and the injection stopper has been made in such a manner that the two parts cannot be pulled off each other without being destroyed.

According to a third aspect of the present invention, the problem is solved by an injection stopper for a bag for medical purposes, wherein the injection stopper has an integrally formed access.

The third aspect of the invention is based on the realization that the basic idea of the present invention not only applies to the manufacturing installation and the manufacturing method but also to the integrally formed access/injection stopper element as such. In particular, a manufacturer offering the installations for manufacturing medical bags and additionally the one-piece access/stopper elements, will be able to ideally match the diameters and the materials of the tool and of the work piece, including in case of modifications. In addition, a conventional access tubule, which ideally has the same outer diameter as the access on the combined element, can also be very easily provided, so that, in an ideal embodiment, it makes no difference to the welding tool, whether a conventional access or a combined access-stopper element is welded to its access.

Preferably, the access of the combined access/injection stopper element is configured as a hollow cylinder. The circular shape on the outside and inside of the access preferably configured as a tube piece or pipe piece, which has been used successfully for many years, can be easily processed on many installations, including existing ones.

The combined injection stopper preferably has a piece of tubing with an outer diameter of 8.0 mm to 9.1 mm, more specifically of approximately 8.0 mm, approximately 8.7 mm or approximately 8.8 mm, in the area of the access.

Accesses in form of tube pieces with the afore-mentioned outer diameters are very frequently found in the prior art. If a combined access-stopper element has a correspondingly sized outer diameter in the area of its access, it can be immediately processed in suitably designed welding tools of existing installations, wherein, as a rule, only the supply needs to be modified.

Rhombic connection or welding areas known from the prior art can also fall within the scope of the present invention.

With regard to its length, it is proposed that the combined access/injection stopper system has a total length along the longitudinal axis of the access of more than 30 mm, more specifically of more than 35 mm or preferably of more than 40 mm.

In practice, injection needles for injecting a medical active substance into the liquid inside the medical bag most often have a length of maximally 40 mm. When the combined system has a total length of 40 mm, the tip of the needle cannot pierce the film when pushed through the rubber seal or through the location provided on the injection stopper for this purpose.

Irrespective of the above considerations, an injection stopper is advantageous when it has a molded access with an inner side made of a first material and, additionally, an elastomer seal made of a second material, wherein a sealing membrane is provided on the access side of the elastomer seal, which has the first material on the side oriented toward the access.

Manufacturers of medical products are subject to very complicated approval procedures. The approval must be obtained for each material that comes into contact with the—most often sterile—interior, or rather with the liquid contained in the filled medical bag. When the stopper is essentially made of polycarbonate or of another rigid, hard material, the stopper is generally hollow and has a sealing material at its end facing away from the bag, i.e. an elastomer and, in practice, often a polyisoprene. The liquid then gets from the inside of the bag into the hollow access, i.e. most often a hollow cylindrical access and contacts its inner surface, so that medical product approval must be obtained for each material provided there, which implies carrying out numerous tests of the reactions between the liquid and the material. In addition, the liquid also gets through the access into the area of the stopper and contacts the elastomer seal inside the hollow plastic body. Thus, the same battery of tests needs to be carried out on the elastomer seal.

In contrast, if a sealing partition wall is placed between the entry (on the inner side of the bag) into the access and the elastomeric seal material, the wall being made of the same material, at least toward the inner side of the bag, as the inner surface at the access or, at any rate, the inner surface of the hollow body channeling the liquid, it is not necessary to carry out a material test of the elastomer in view of an approval. Indeed, the liquid is not contacted by the liquid when not inserted in the bag. If an injection needle is now pushed through the elastomer seal, the needle also traverses the sealing membrane after having passed through the elastomer seal and reaches the liquid inside the medical bag.

To the person skilled in the art, sizing the sealing membrane as a function of the injection needles to be used for insertion and of the material from which the sealing membrane is to be made, in a manner resulting in a safe separation effect, while not pierced, but allowing the injection needle to be passed through the sealing membrane under a reasonable force application is a matter of simple craftsmanship.

According to a fifth aspect of the present invention, the problem is solved by an injection stopper for a bag for medical purposes, wherein the injection stopper has a molded access with a hollow cylindrical shape, wherein the access has a wall thickness of more than 1.0 mm.

In the prior art, the access is usually a plastic tube. The known tubes have a wall thickness of less than 1.0 mm. As a consequence, the amount of the relatively expensive material required for producing the access is relatively small. However, the tubes are not inherently stable and tend to rapidly hang downward, when oriented horizontally and mounted at only one end. Therefore, in the prior art, insertion mandrins, i.e. metal rods centrally inserted into the tubules, have been used in thermoforming installations for inserting the tube pieces. These mandrins made it possible to precisely predict the position of the tubules, resulting in an efficient weld-in process in a thermoforming installation.

Now, if the access is already equipped with a stopper on its side facing away from the bag, it is no longer possible to introduce a support from the side facing away from the bag. It is possible but more complicated to grip the tubules from the outside. It is even more complicated to hold the tubules, which by nature are open toward the bag interior, from the inside of the bag with an insertion mandrin.

However, if the structure in the area of the access is so stable that the wall thickness amounts to more than 1.0 mm, preferably more than 1.1 mm, 1.2 mm, 1.3 mm, 1.4 mm, 1.5 mm, 1.6 mm, 1.7 mm, 1.8 mm, 1.9 mm or even 2.0 mm, the tube has such a high inherent stability due to the increased moment of inertia, that an unpredictable sagging, as known hitherto from existing tubes, is no longer to be feared.

It is proposed that the combined injection stopper has a grooved structure at the outside of the access. A grooved structure has proved to be effective when welded between the film layers in a thermoforming process.

According to a sixth aspect of the present invention, the problem is solved by a bag for medical purposes, which is empty or filled with a fluid, with a bag interior between two film layers and with an access, designed as a body, to the bag interior and with an injection stopper, wherein the access is integrally formed with the injection stopper, wherein the bag preferably has an injection stopper as previously described.

It goes without saying that the afore-mentioned advantages also directly apply to the bag equipped with a combined one-piece access/stopper element.

It also goes without saying that it is advantageous, in particular for filling the bag, if in addition to the integrally formed access/injection stopper structure, a tube is welded between the film layers and features an extraction stopper. If the bag is to be full when leaving the production installation, the bag should already be full the moment the extraction stopper is provided.

In the following, the invention is described in more detail based on exemplary embodiments with reference to the drawing.

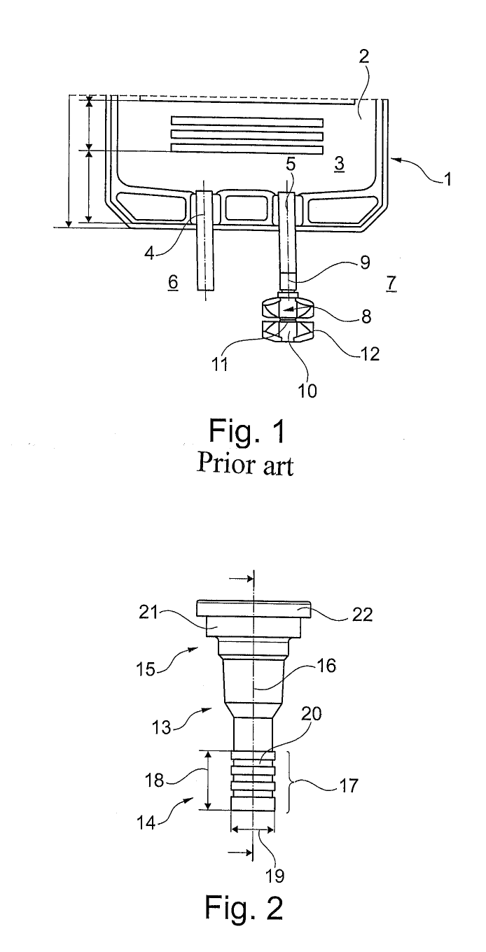

FIG. 1 schematically shows a top view of a head region of an infusion bag with two accesses, wherein an injection access is closed by an injection stopper, as known from the prior art,

FIG. 2 schematically shows a top view of an access/injection stopper element,

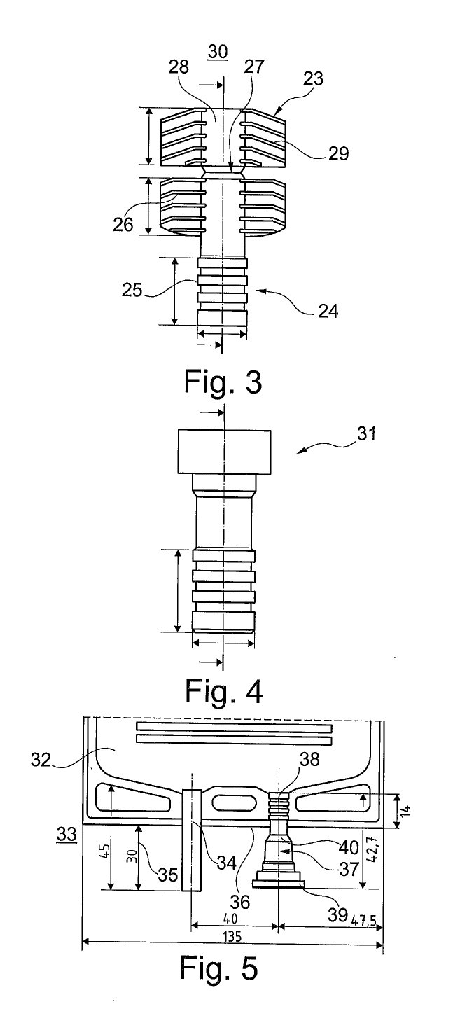

FIG. 3 shows a view similar to FIG. 2 of a second embodiment of such an element,

FIG. 4 shows a third embodiment of such an element in the same top view as in FIGS. 2 and 3,

FIG. 5 shows a schematic top view similar to FIG. 1 of a head of an injection bag with the inserted element of FIG. 2, and

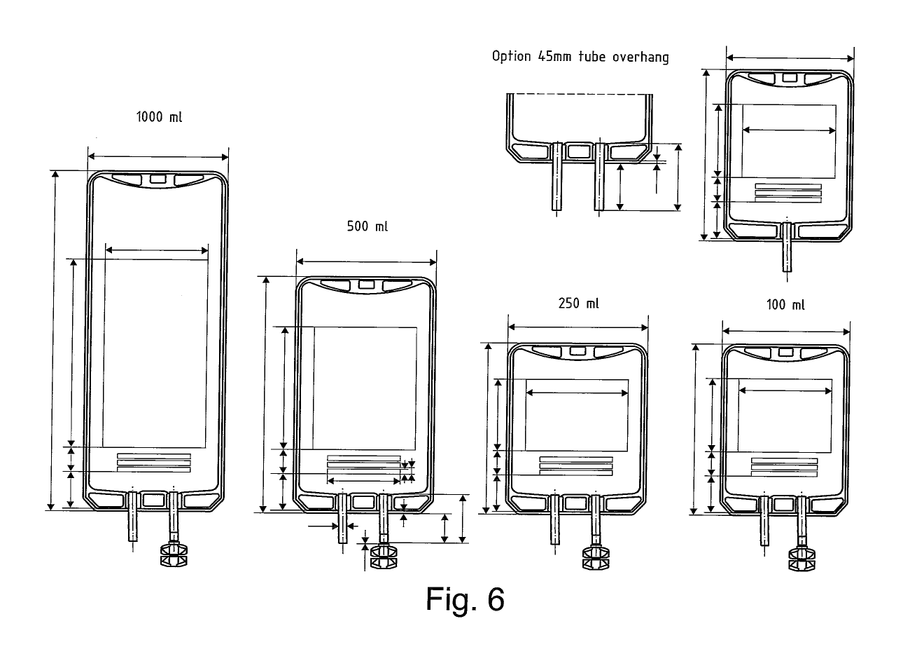

FIG. 6 shows various bag shapes and embodiments in a schematic top view, respectively exemplarily with the element of FIG. 3.

The infusion bag 1 of FIG. 1 essentially consists of an upper film 2 and a lower film (covered by the upper film 2). The infusion bag 1 is already manufactured. There are two accesses to an interior space 3, namely a first access 4 and a second access 5, both configured as hollow cylindrical plastic tubes of equal length. The first access 4 is located on an extraction side 6 of the infusion bag 1, whereas the second access 5 is located on an injection side 7 of the infusion bag 1.

The plastic tubule of the second access 5 on the injection side 7 is closed by a twist-off injection stopper 8. A stopper part 9 is located in a tightly clamped fit in the plastic tubule of the second access 5. For its part, the stopper part 9 is formed in a plastic hollow cylinder 10 of the twist-off injection stopper 8 by means of an elastomer (not numbered). A predetermined shearing point 11 in the form of a peripheral weakening of the wall thickness of the plastic hollow cylinder 10 is formed on the side of the sealed-off plastic hollow cylinder 10 facing away from the infusion bag 1, and respectively one double wing arrangement 12 (exemplarily labeled) is provided on both sides of the predetermined shearing point 11, i.e. both on the side oriented toward the infusion bag 1 and on the side oriented away from the infusion bag.

In order to fill the infusion bag 1, the open plastic tubule of the first access 4 is used, which is then closed with an extraction stopper (not inserted yet).

When the infusion bag 1 is used for a medical application, it is suspended with both accesses in a head region of the bag (shown in FIG. 1) oriented downward. By rotating the respectively two double wings in the double wing arrangement 12 relative to each other, usually with both hands, the closure of the second access 5 of the plastic tubule is opened. A so-called spike port is jammed into the plastic hollow cylinder 10 of the twist-off injection stopper 8. The liquid is extracted through this spike port. The spike port can only be removed when the bag is empty or no longer needs to be used, because otherwise the second access 5 will no longer be sealed.

Two components are thus used on the injection side 7 of the infusion bag 1, which are inserted successively during manufacture: first, the plastic tubule in the second access 5, which is welded to the infusion bag 1. Once this has occurred, the twist-off injection stopper 8 is sealingly jammed into the tubule on its side facing away from the infusion bag 1 in a subsequent work step.

In contrast, the one-piece, combined access/stopper element 13 in FIG. 2 is designed to be directly welded into the two film layers of a medical bag.

The access/stopper element 13 consists essentially of two separate functional parts, namely on the one hand an access part 14 and on the other an injection stopper part 15, which both extend along a longitudinal extension axis 16, which in the present example is also an axis of rotational symmetry. The access part 14 is uniformly manufactured from an access material. It is hollow and has a wall thickness of e.g. slightly more than 1.0 mm.

In a welding area 17, the access/stopper element 13 has a welding length 18 adjusted to a welding tool of e.g. approximately 12 mm and an outer diameter 19 of e.g. 8.7 mm.

Rotationally symmetric grooves 20 (exemplarily labeled) are disposed in the welding area 17.

The access/stopper element 13 widens as it extends along the longitudinal extension axis 16, namely both with regard to its outer diameter and to its inner diameter. In the present representation, a multistage widening is provided. However, a widening can also be dispensed with, or a continuous or one-stage widening can be carried out, or a tapering.

An elastomeric sealing stopper 22, i.e. made of another material, on a hollow collar 21 of the access part 14 is firmly fitted in the tubular access part 14, in such a manner that it completely seals it off. For example, a clamping fit with a sufficient sealing force can be used, or for example a sealing adhesive, or a labyrinth seal, or any other sealing means.

Due to the fixed connection of the elastomeric sealing stopper 22 with the tubular body of the access part 14, this can be referred to as a one-piece combined element of the access and the stopper.

During production, the sealing area 17 on the access part 14 is intended to be welded with its outer diameter having the grooves 20 between the two film layers. Since the access/stopper element 13 in FIG. 2 is open only on the side of the access part 14, while being completely closed by the elastomeric sealing stopper 22 on the side facing away from the future bag, a mandrin protruding into the hollow element from the side facing away from the bag is technically dispensed with. Therefore, the access/stopper element is either welded or otherwise attached in a previous work step preceding the final welding, or it is held for welding from the outside. For the sake of completeness, it must be mentioned, that another holding option can of course also be provided on the side of the elastomeric sealing stopper, now shown, facing away from the bag, for example directly by way of an extension of the elastomeric sealing stopper, wherein it must be taken care that the total length of the entire access/stopper element 13 is still adjusted to the intended length of the injection needle.

Once a tight welding of the welding area 17 with the plastic layers of the infusion bag has taken place in the production installation, the bag is automatically sealed off at its access.

During a later injection, an injection needle can be inserted through the elastomeric sealing stopper 22 ideally almost up to the end of the access part 14 of the bag. If an active substance is injected in this manner, it will be well distributed in the inner area of the bag, but the syringe will still be inside the tubular, stable access part 14 of the access/stopper element 13, so that it cannot damage the thin plastic layer of the bag from the inside.

The second embodiment 23 of a combined one-piece access/stopper element 13 in FIG. 3 is manufactured according to a so-called twist-off design. The second embodiment 23 is similarly formed by an access part 24 extending along the greatest part, by far, of the combined element. The access part begins on the side of the bag with a welding area 25 having the same design as the first embodiment in FIG. 2, then continues with a tubular shape, this time without widening, but rather with a tapering of the outer diameter, and up to two holding wings 26 (exemplarily labeled) and to a predetermined shearing point 27 formed by a reduction of the wall thickness. The second embodiment 23 continues in the same material, and thus, in the strict sense, even in a one-piece configuration, beyond the predetermined shearing point 27 up to a stopper part 28, which features a pair of rotary wings 29 (exemplarily labeled). On its side 30 facing away from the future bag, the plastic tubular structure of the second embodiment 23 has a closed configuration.

In practice, the access part 24 is again welded with its welding area 25 between the plastic layers, so that it is securely sealed off.

The injection bag is then tightly sealed.

The stopper part 28 is sheared off around the longitudinal extension axis by holding the holding wings 26 and simultaneously rotating the rotary wings 29, so that the second embodiment with its tubular body is open on both sides, so that there is a connection between the bag interior on the access side and the outer side at the predetermined shearing point 27. A substance injection port can be press fitted there.

The third embodiment 31 of a combined one-piece access/stopper element in FIG. 4 corresponds to the first exemplary embodiment of FIG. 2 in terms of the design principle but with different geometries. The third embodiment 31 must therefore be understood as illustrating the fact that numerous geometries can be used, the technical basic principle being identical in the first embodiment and in the third embodiment 31.

The bag 32 in FIG. 5, which is finally ready to be filled, has a welded plastic tubule 34 on its extraction side 33, which has, for example, a total length of more than 40 mm, of which however only 30 mm, for example, form a projection 35 over the edge of the bag 36.

On the injection side of the bag 32, a one-piece combined access/stopper element 37 is welded directly with its welding part 38 between the film layers of the bag 32, ideally with the same projection. The sealing elastomer 39 is firmly fitted in and ideally not non-destructively removable from the access part 40 of the access/stopper element 37.

It goes without saying that various embodiments of a combined access/stopper element can be installed in differently shaped bags and in various numbers of accesses, without deviating from the basic idea of the invention. FIG. 6 shows a small selection of various forms, ranging from a 100 ml bag to a 1,000 ml bag, wherein, in practice, both limits must not be understood as limitations.

In addition, it is shown in the upper area of the figures that the projection can also be greater, for example 45 mm, a shorter projection length being also conceivable.

Incidentally, it must be mentioned that it is particularly advantageous if a combined access/stopper element is manufactured by injection molding. This is considerably more cost-effective than the tube extrusion processes under sterile conditions known from the prior art.

In an installation set up to manufacture multiple accesses to a bag with its tool, the operator of the installation is preferably provided with the choice to equip any number of accesses with conventional open tubules. Thus, it is possible to choose, in an installation for manufacturing bags with two accesses, whether both accesses are to be equipped with conventional open tubules for a faster filling process, or whether one of the two open access tubules must be replaced with a combined access/stopper element, which is however closed, so that this access may not be used for filling the bag and filling takes more time. The formation of a temporal bottleneck that noticeably slows down the machine cycle will depend on the size of the bags and on the other stations of the installation.

### LIST OF REFERENCE NUMERALS

1 infusion bag

2 upper film

3 interior space

4 first access

5 second access

6 extraction side

7 injection side

8 twist-off injection stopper

9 stopper part

10 plastic cylinder

11 predetermined shearing point

12 double-wing arrangement

13 access/stopper element

14 access part

15 injection stopper part

16 longitudinal extension axis

17 welding area

18 welding length

19 outer diameter

20 grooves

21 collar

22 elastomer sealing stopper

23 second embodiment

24 access part

25 welding area

26 holding wing

27 predetermined shearing point

28 stopper part

29 rotary wing

30 facing away side

31 third embodiment

32 bag

33 extraction side

34 plastic tubule

35 projection

36 bag edge

37 access/stopper element

38 welding part

39 elastomer

40 access part

1. An installation for manufacturing a bag for medical purposes from two film layers, an access and an injection stopper, wherein the access features a tube, wherein the installation is set up to weld an injection stopper with an integrally formed access between the film layers.

2. The installation according to claim 1, wherein an access welding tool is provided, wherein the access welding tool features a supply of injection stoppers that are separate from accesses.

3. The installation according to claim 1, wherein an access welding tool is provided, wherein the access welding tool features a supply of accesses that are separate from injection stoppers.

4. The installation according to claim 1, wherein an access welding tool is provided, wherein the access welding tool has a supply of one-piece combined access/injection stopper elements.

5. The installation according to claim 2, wherein multiple supplies are provided for optional use.

6. The installation according to claim 1, wherein the installation is designed so that it is devoid of an injection stopper fitting station.

7. A method for manufacturing a bag for medical purposes from two film layers, an access and an injection stopper in an industrial installation, wherein in the installation, an injection stopper with an integrally formed access in the form of a tube is used and wherein the access is welded between two film layers, wherein welding is carried out at the access.

8. An injection stopper for a bag for medical purposes, wherein the injection stopper has an integrally formed access.

9. The injection stopper according to claim 8, wherein the access of the injection stopper is designed hollow-cylindrical.

10. The injection stopper according to claim 8, wherein a tube piece with an outer diameter of 8.0 mm to 9. 1 mm, more specifically of approximately 8.0 mm, 8.7 mm or 8.8 mm is provided in the area of the access.

11. The injection stopper according to claim 8, wherein the injection stopper including the access has a length of more than 30 mm, more specifically more than 35 mm, or preferably more than 40 mm, along the longitudinal axis of the access.

12. The injection stopper according to claim 8, for a bag for medical purposes, wherein the injection stopper has a molded access with an inner side made of a first material and wherein the injection stopper has an elastomer seal made of a second material, wherein a sealing membrane is provided on the access side of the elastomer seal, which has the first material on its side facing the access.

13. The injection stopper according to claim 8, for a bag for medical purposes, wherein the injection stopper has a molded access with a hollow-cylindrical shape, wherein the access has a wall thickness of more than 1.0 mm.

14. The injection stopper according to claim 8, wherein the injection stopper has a grooved structure on the outside of the access.

15. A bag for medical purposes, empty or filled with a fluid, with a bag interior between two film layers and with an access to the bag interior formed as a body and with an injection stopper, wherein the access is integrally formed with the injection stopper, wherein the bag preferably has an injection stopper according to claim 8.

16. The bag according to claim 15, wherein a tube is welded between the film layers in addition to the integrally formed access/injection stopper structure and has an extraction stopper.
